(19) United States
(12) Patent Application Publication
(10) Pub. No.: US 2018/0267305 A1
(43) Pub. Date: Sep. 20, 2018

(54) VIDEO SWITCHING APPARATUS, VIDEO SWITCHING SYSTEM, AND VIDEO SWITCHING METHOD

(71) Applicant: ATEN International Co., Ltd., New Taipei City (TW)

(72) Inventor: CHUN-CHI LIAO, New Taipei City (TW)

(73) Assignee: ATEN International Co., Ltd., New Taipei City (TW)

(21) Appl. No.: 15/914,774

(22) Filed: Mar. 7, 2018

(30) Foreign Application Priority Data
Mar. 14, 2017 (TW) 106108390

(51) Int. Cl. G02B 27/01; G06F 3/01; G06F 3/14

(52) U.S. Cl. CPC G02B 27/0101; G09G 2370/24; G06F 3/14; G06F 3/012

(57) ABSTRACT

The present invention provides a video switching apparatus, a video switching system, and a video switching method. The video switching apparatus includes a video generating unit and a processing unit. The video generating unit receives a first video signal forming a first video picture and a second video signal forming a second video picture, and generates a display video signal to be displayed on the head mounted device, wherein the display video signal is adjusted to form a first mode picture or a second mode picture, and the first mode picture includes at least a portion of the first video picture and at least a portion of the second video picture. The processing unit receives a first sensing signal from a sensing unit and outputs a first switching signal to the video generating unit. The video generating unit generates the display video signal corresponding to the first mode picture or the second mode picture based on the first switching signal.

### BACKGROUND OF THE INVENTION

### Field of the Invention

This invention relates to video processing, and in particular, it relates to a video switching device, video switching system, and video switching method.

### Description of Related Art

Keyboard-video-mouse switches (KVM switches) are used to connect between control devices of the user terminal and a plurality of controlled computers (target computers), to allow a user to use one set of keyboard, monitor and mouse to control a plurality of controlled computers. Network-based KVM switches (IP-based KVM, or KVM over IP) is a KVM switch with a network interface, to allow a user of a desktop or notebook computer to remotely, via a network, manage a plurality of controlled computers located at a remote site and to operate individual controlled computers.

Conventionally, for KVM switches and IP-based KVM switches, the user at the control terminal need to use a set of keyboard, monitor and mouse to control the plurality of controlled computers and to monitor the images on the controlled computer. A managing and control device that can be used for KVM switches and IP-based KVM switches, which is innovative, easy to use and feasible, is needed.

### SUMMARY

The present invention is directed to a video switching device, video switching system, and video switching method which can use virtual reality (VR) glasses in a KVM switch system. Embodiments of the present invention provide a video switching device to be used with a head mounted device and a sensing unit. The video switching device includes a video generating unit and a processing unit. The video generating unit receives a first video signal that forms a first video picture and a second video signal that forms a second video picture, and generates a display video signal to be displayed on the head mounted device, wherein the display video signal is adjusted to form a first mode picture or a second mode picture. The first mode picture includes at least a portion of the first video picture and at least a portion of the second video picture. The processing unit receives a first sensing signal from the sensing unit and outputs a first switching signal to the video generating unit. Based on the first switching signal, the video generating unit generates a display video signal corresponding to the first mode picture or the second mode picture.

Embodiments of the present invention also provides a video switching system, including a first video source, a second video source, a head mounted device, a sensing unit, a processing unit and a video generating unit. The first video source provides a first video signal that forms a first video picture. The second video source provides a second video signal that forms a second video picture. The head mounted device is configured to be worn on the head of the user, and has a display screen. The sensing unit senses a first movement gesture of the user's head and outputs a first sensing signal. The processing unit receives the first sensing signal and outputs a first switching signal. The video generating unit receives the first video signal and the second video signal, and generates a display video signal for display by the display screen, where the display video signal is adjusted to form a first mode picture or a second mode picture, the first mode picture including at least a portion of the first image picture and at least a portion of the second image picture. When the video generating unit receives the first switching signal, the video generating unit generates a display video signal corresponding to the first mode picture or the second mode picture.

Embodiments of the present invention also provides a video switching method, implemented in a video switching device and a head mounted device. The video switching method includes the following steps. The video switching device receives a first video signal that forms a first image picture and a second video signal that forms a second image picture, and outputs a display video signal to the head mounted device to be displayed, where the display video signal is adjusted to form a first mode picture or a second mode picture. The video switching device, in response to a first sensing signal from the head mounted device, outputs a display video signal corresponding to the first mode picture or the second mode picture to the head mounted device for display, where the first sensing signal is generated in response to sensing a first movement gesture of the head mounted device.

Additional characteristics and advantages of the present invention will become clear from the following description, or can be learned by implementing the invention. Other objectives and advantages of the present invention can be understood from the detained descriptions, the drawings and the claims.

### BRIEF DESCRIPTION OF THE DRAWINGS

FIG. 1 schematically illustrates a video switching system according to a first embodiment of the present invention.

FIGS. 2A-2C illustrate various implementations of a browsing mode picture.

FIGS. 3A-3B illustrate various implementations of a locked mode picture.

FIG. 4 illustrates a line of sight of a user.

FIG. 5 schematically illustrates a video switching system according to a second embodiment of the present invention.

FIG. 6 illustrates an implementation of a third mode picture.

FIG. 7A illustrates an implementation of a display screen having a video display region and an avoidance region.

FIG. 7B illustrates another implementation of a display screen having a video display region and an avoidance region.

### DETAILED DESCRIPTION OF PREFERRED EMBODIMENTS

Embodiments of the present invention use a head mounted device to replace conventional keyboard, monitor and mouse to control a KVM switch. The head mounted devices refer to virtual reality (VR) glass which is configured to be worn on the user's head. The conventional display means (with an ordinary monitor screen) of the control terminal is replaced by the display screen of the VR glass, and the conventional means of switching and managing the controlled computer (by keyboard and mouse) is replaced by operations of the VR glass. Specific embodiments of the invention are described in detail below.

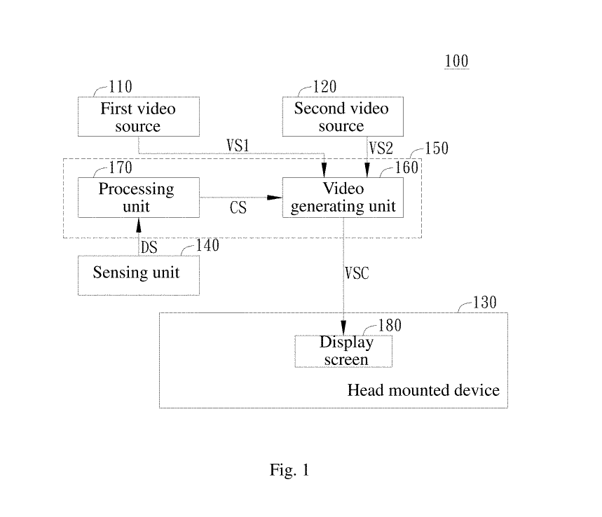

Refer to FIG. 1, which schematically illustrates a video switching system according to a first embodiment of the present invention. The video switching system 100 includes a first video source 110, a second video source 120, a head mounted device 130, a sensing unit 140, and a video switching device 150. The video switching device 150 includes a video generating unit 160 and a processing unit 170. The processing unit 170 may include a central processing unit, a microprocessor, etc. The head mounted device 130 is equipped with a display screen 180. The display screen 180 may include a liquid crystal display (LCD), a light emitting diode (LED) screen, an organic LED screen, a transparent display screen, or other display screens.

In this embodiment, the first video source 110 may be, for example, a local video source (such as an audiovisual playback device), and the second video source 120 may be, for example, a remote video source (such as a remote computer or an IP-based KVM switch), but they are not limited to such. The first video source 110 and the second video source 120 may be respectively connected to the video generating unit 160 by wired or wireless connections. Also, this embodiment uses two video sources as an example (the first video source 110 and the second video source 120), but in practical use, there may be more than two video sources. The first video source 110 provides a first video signal VS1 that forms a first image picture VF1 and outputs the signal to the video generating unit 160, and the second video source 120 provides a second video signal VS2 that forms a second image picture VF2 and outputs the signal to the video generating unit 160.

The video generating unit 160 receives the first video signal VS1 and the second video signal VS2, and generates a display video signal VSC for display on the display screen 180 of the head mounted device 130. The display video signal VSC is adjusted to the first mode picture or the second mode picture.

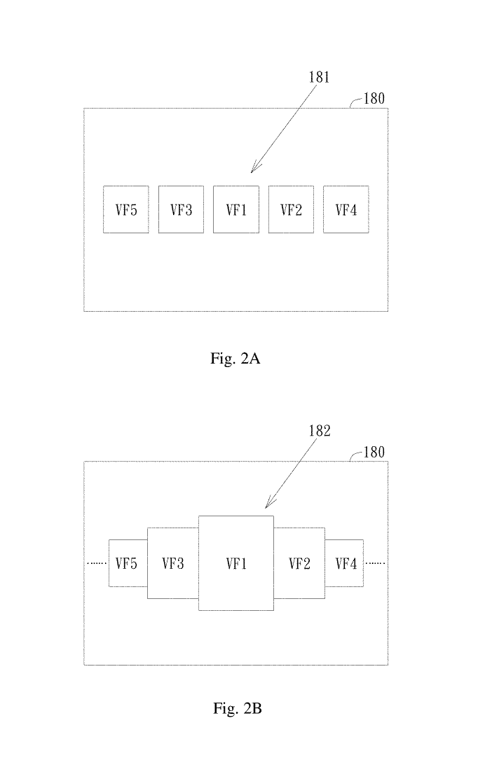

In this embodiment the first mode picture is a browsing mode picture, which includes the image pictures supplied by multiple video sources. For example, as shown in FIG. 2A, the browsing mode picture 181 is rendered as linearly arranged multiple image pictures (first image picture VF1, second image picture VF2, and other image pictures VF3-VF5). Or, as shown in FIG. 2B, the browsing mode picture 182 is rendered as wheel shape arranged multiple image pictures (first image picture VF1, second image picture VF2, and other image pictures VF3-VF5). Or, as shown in FIG. 2C, the browsing mode picture 183 is rendered as an array (e.g., 3×3 array) of multiple image pictures (first image picture VF1, second image picture VF2, and other image pictures VF3-VF9). It should be noted that the browsing mode picture of this invention is not limited to the browsing mode pictures 181-183 shown in FIGS. 2A-2C. For example, the browsing mode picture may have randomly arranged, ring shaped, or other arrangements of the multiple image pictures. Further, in FIGS. 2A-2C, the individual image pictures in the browsing mode pictures 181-183 are complete image pictures, but in other embodiments, each image picture may show only a portion of the whole image picture supplied by the respective video source.

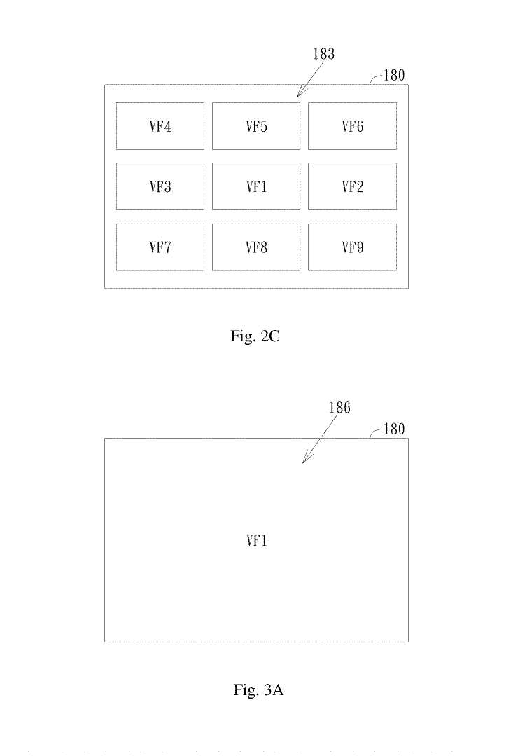

In this embodiment, the second mode picture is a locked mode picture. For example, as shown in FIG. 3A, the locked mode picture 186 renders an enlarged first image picture VF1 which covers the entire visible area of the display screen 180, while other image pictures (e.g. VF2-VF5 in FIG. 2A) disappears or are covered. Or, as shown in FIG. 3B, the locked mode picture 187 renders an enlarged first image picture VF1, while the other image pictures (e.g. VF2-VF5 in FIG. 2A) are rendered with reduced display sizes.

The processing unit 170 receives sensing signals DS from the sensing unit 140, and outputs switching signals CS to the video generating unit 160. The sensing signals DS are generated by the sensing unit 140 by sensing movement gestures of the head mounted device 130. In one embodiment, the sensing unit 140 may be an electromagnetic tracker, ultrasound tracker, optical tracker, etc. For example, without limitation, it may be located in front of the head mounted device 130 to sense the movement gesture of the head mounted device 130. In another embodiment, the sensing unit 140 is preferably disposed on the head mounted device 130 to sense the movement gesture of the head mounted device 130, where the sensing unit 140 may include a gravity sensor, a gyroscope, or a combination thereof. The video generating unit 160, based on the switching signal CS, generates the display video signal VSC corresponding to the first mode picture or the second mode picture.

For example, when the processing unit 170 receives a first sensing signals DS1 from the sensing unit 140, it outputs a first switching signal CS1 to the video generating unit 160; the video generating unit 160, based on the first switching signal CS1, generates a display video signal VSC corresponding to the first mode picture (such as the browsing mode picture 181-183 described earlier) and sends it to be displayed by the display screen 180 of the head mounted device 130. When the processing unit 170 receives a second sensing signals DS2 from the sensing unit 140, it outputs a second switching signal CS2 to the video generating unit 160; the video generating unit 160, based on the second switching signal CS2, generates a display video signal VSC corresponding to the second mode picture (such as the browsing mode picture 186-187 described earlier) and sends it to be displayed by the display screen 180 of the head mounted device 130.

Various embodiments are described below to illustrate how the sensing unit 140 senses the various movement gestures of the head mounted device 130 and causes the display screen 180 of the head mounted device 130 to display the corresponding mode picture. Here, the example of a sensing unit 140 disposed on the head mounted device 130 is used.

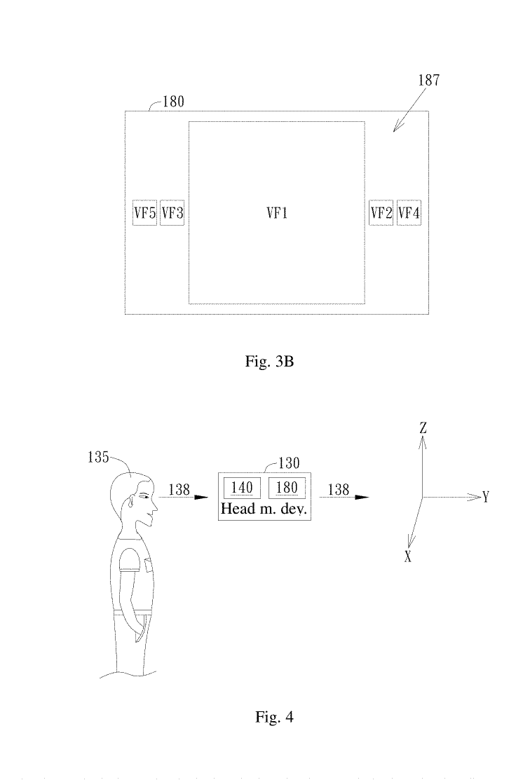

Refer to FIG. 4, which illustrates a line of sight of a user. The head mounted device 130 is worn on the head 135 of the user. Typically, it is worn on the head 135 in front of the user's eyes. In this embodiment, the horizontal direction parallel to the user's line of sight 138 is defined as the Y axis; the horizontal direction perpendicular to the user's line of sight 138 is defined as the X axis; and the vertical direction perpendicular to the user's line of sight 138 is defined as the Z axis. Preferably, the user's line of sight 138 is defined as the line from the eyes to the center position of the display screen 180.

In one embodiment, the head 135 of the user may move forward and backward along the Y direction (as the movement gesture of the head mounted device 130), so as to change the number of image pictures rendered on the browsing mode picture. For example, when the display screen 180 of the head mounted device 130 displays a browsing mode picture 181 as shown in FIG. 2A, if the user's head 135 moves forward, this gesture can result in the browsing mode picture 181 changing from displaying five image pictures down to three image pictures or fewer. On the other hand, if the user's head 135 moves backward, this gesture can result in the browsing mode picture 181 changing from displaying five image pictures up to seven image pictures or more. Or, when the display screen 180 of the head mounted device 130 displays a browsing mode picture 183 as shown in FIG. 2C, if the user's head 135 moves forward, this gesture can result in the browsing mode picture 183 changing from a 3×3 array of image pictures to a 2×2 array to render fewer image pictures. On the other hand, if the user's head 135 moves backward, this gesture can result in the browsing mode picture 183 changing from a 3×3 array to a 4×4 array to render more image pictures.

In one embodiment, the user's head 135 may move to the left or right along the X axis, or turn around the Z axis (e.g. turning the head left or right, similar to shaking head), so as to change the displayed image pictures in front of the line of sight 138. For example, when the display screen 180 of the head mounted device 130 displays a browsing mode picture 181 as shown in FIG. 2A, if the user's head 135 turns to the left, this gesture can result in all image pictures of the browsing mode picture 181 moving to the left by one position; for example, the second image picture VF2 will move to the center of the display screen 180 (i.e. the position previously occupied by the first image picture VF1), while the first image picture VF1 will move to the position previously occupied by the image picture VF3, and an image picture not previously displayed on the display screen 180 will now be displayed to the right of the image picture VF4. Similarly, if the user's head 135 turns to the right, this gesture can result in all image pictures of the browsing mode picture 181 moving to the right by one position; for example, the image picture VF3 will move to the center of the display screen 180 (i.e. the position previously occupied by the first image picture VF1), while the first image picture VF1 will move to the position previously occupied by the image picture VF2, and an image picture not previously displayed on the display screen 180 will now be displayed to the left of the image picture VFS.

Note that when the user moves his head, a given head movement is often followed by an opposite movement to return the head to its initial position. For example, when the user turns his head to the left in the above example, this movement is typically followed by a turn to the right to return to the “unturned” position even though the user does not intend to move the image pictures to the right. To prevent signal ambiguity, the processing unit 170 may be configured such that it receives after a first sensing signal DS representing a head movement, if a second sensing signal DS representing an opposite head movement is received within a predetermined time interval (e.g., one second) of the first sensing signal, the processor ignores the second sensing signal, i.e., it only outputs a switching signal CS based on the first sensing signal and will not output a switching signal based on the second sensing signal. In other examples, the processing unit 170 may be configured to interpret two successive movements in opposite directions as one gesture. For example, when the processor is expecting a “yes” (confirm) or “no” (cancel) input, it will interpret shaking head back and forth as “no” and nodding head down and up as “yes”.

In one embodiment, the head 135 of the user may move up and down along the Z direction or turn around the X axis (e.g. nodding the head up and down), so as to select the image picture currently located at the line of sight 138 and enter the locked mode picture. For example, when the display screen 180 of the head mounted device 130 displays a browsing mode picture 181 as shown in FIG. 2A and the line of sight 138 is on the first image picture VF1, if the user's head 135 nods down or if the head stays at the same position for a time period longer than a predetermined time period, indicating the user wishes to select the first image picture VF1, this gesture can result in the display screen 180 changing to the locked mode picture 186 as shown in FIG. 3A. Subsequently, if the user shakes his head 135 (e.g. the user's head 135 moves left and right along the X axis or turn around the Z axis), indicating the user wishes to cancel the first image picture VF1, the locked mode picture 186 shown in FIG. 3A will return to the browsing mode picture 181 shown in FIG. 2A, for example by shrinking the previously enlarged locked mode picture 186 and outputting the browsing mode picture 181 to be displayed on the display screen 180 of the head mounted device 130.

In various implementations, the sensing unit 140 can sense the linear translation movements of the head mounted device 130 along each axis, or the angular movements of the head mounted device 130 around each axis, and output corresponding sensing signals.

In one embodiment, when the display screen 180 of the head mounted device 130 displays a browsing mode picture 181 as shown in FIG. 2A and the head stays at the same position, this gesture can result in an increase of the image resolution of the first image picture VF1 and a decrease of the image resolutions of the other image pictures VF2-VFS. This can greatly decrease the transmission bandwidth requirement without sacrificing image quality.

It should be noted that, for each of the defined gestures of the head mounted device 130 (including the forward and backward movements, left or right turns, nodding or shaking of the head 135), the user can set a threshold value, and the movement amplitudes of the various gestures of the head mounted device 130 are evaluated to determine whether they reach the respective threshold values, in order to determine whether the corresponding operation should be executed. For example, when the display screen 180 displays a locked mode picture 186 as shown in FIG. 3A and the user wishes to continue to view the first image picture VF1, because the user's head 135 cannot always be maintained stationary, when the user's head 135 turns left and right slightly and the amplitude of the movement does not reach the corresponding threshold, it indicates the user does not wish to cancel the selected first image picture VF1, so the display screen 180 continues to display the locked mode picture 186 without any change.

Using the above determination method, erroneous switching operations due to the user's unintentional small movements of the head can be effectively avoided. This determination step is preferably performed by the processing unit 170 shown in FIG. 1. For example, the processing unit 170 can judge whether the sensing signals DS transmitted from the sensing unit 140 reach the corresponding threshold values in order to determine whether to output a corresponding switching signal CS to the video generating unit 160.

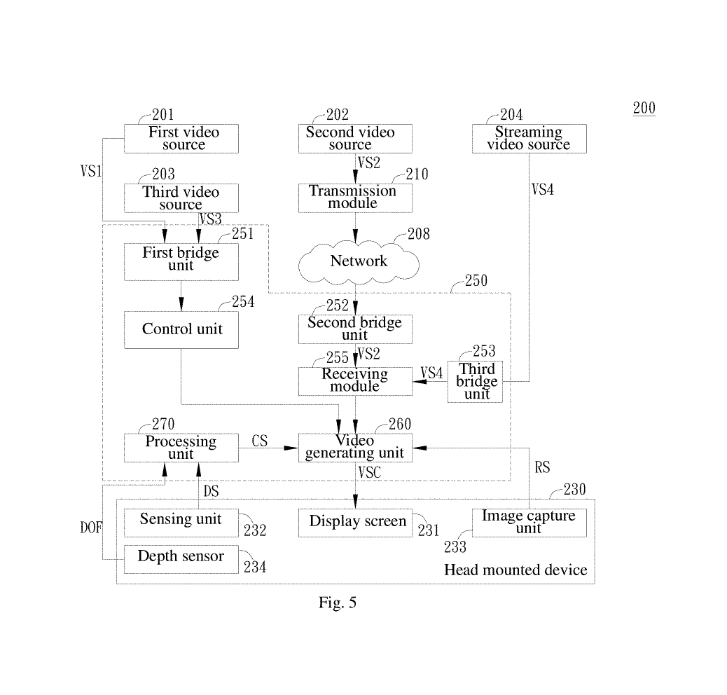

Refer to FIG. 5, which schematically illustrates a video switching system according to a second embodiment of the present invention. The video switching system 200 includes a first video source 201, a second video source 202, a third video source 203, a streaming video source 204, a transmission module 210, a head mounted device 230 and a video switching device 250. The head mounted device 230 includes a display screen 231, a sensing unit 232, an image capture unit 233 and a depth sensor 234. The video switching device 250 includes a first bridge unit 251, a second bridge unit 252, a third bridge unit 253, a control unit 254, a receiving module 255, a video generating unit 260, and a processing unit 270. This embodiment is similar to the first embodiment, and the similar or same parts are not described in detail.

In this embodiment, the first video source 201 and the third video source 203 are, for example, local video sources, the second video source 202 is, for example, a remote video source, and the streaming video source 204 is, for example, a real-time streaming video source (such as a video camera) or pre-recorded video (such as a video file stored on a hard drive), but they are not limited to such. The first video source 201 provides a first video signal VS1 that forms a first image picture VF1 and outputs it to the first bridge unit 251. The second video source 202 provides a second video signal VS2 that forms a second image picture VF2 and outputs it to the transmission module 210, and the transmission module 210 encodes the second video signal VS2 and transmits it via a network 208 to the second bridge unit 252. The third video source 203 provides a third video signal VS3 that forms a third image picture VF3 and outputs it to the first bridge unit 251. The streaming video source 204 provides a fourth video signal VS4 that forms a fourth image picture VF4 and outputs it to the third bridge unit 253. The first bridge unit 251, the second bridge unit 252 and the third bridge unit 253 are interface connectors, such as RJ45 connectors for network signals, VGA (Video Graphics Array), HDMI (High-Definition Multimedia Interface), DVI (Digital Visual Interface) or DisplayPort connectors for video signals, USB (Universal Serial Bus) connector for data, or SATA (Serial AT Attachment) connectors for hard disk, etc.

The control unit 254 is couple dot the first bridge unit 251 to control the output of the first video signal VS1 or the third video signal VS3 to the video generating unit 260. The control unit 254 may include a switch or a multiplexer. The receiving module 255 is coupled to the second bridge unit 252, the third bridge unit 253 and the video generating unit 260. The receiving module 255 receives and decodes the second video signal VS2 from the second bridge unit 252, and transmits the decoded second video signal VS2 to the video generating unit 260. Further, the receiving module 255 receives the fourth video signal VS4 from the fourth bridge unit 254, converts the fourth video signal VS4 to a format that can be processed by the video generating unit 260, and transmits the converted signal to the video generating unit 260.

The video generating unit 260 receives the first video signal VS1 or the third video signal VS3 from the control unit 254, and the second video signal VS2 and/or the fourth image picture VF4 from the receiving module 255, and generates a display video signal VSC and outputs it to the display screen 231 of the head mounted device 230 to be displayed. The display video signal VSC can be at least adjusted to form a first mode picture or a second mode picture. In this embodiment, the first mode picture may include, without limitation, the browsing mode pictures 181-183 shown in FIGS. 2A-2C, and the second mode picture may include, without limitation, the locked mode picture 186-187 shown in FIGS. 3A-3B; these pictures are not described further here.

The processing unit 270 receives sensing signals DS from the sensing unit 232 and outputs corresponding switching signals CS to the video generating unit 260. The sensing signals DS are generated by the sensing unit 232 sensing the movement gestures of the head mounted device 230. In this embodiment, the sensing unit 232 is preferably disposed on the head mounted device 230 to sense the movement gestures of the head mounted device 230. The sensing unit 232 may include a gravity sensor, a gyroscope, or a combination thereof. The video generating unit 260 generates, in response to the switching signal CS, the display video signal VSC corresponding to the first mode picture or the second mode picture and outputs it to the display screen 231 of the head mounted device 230 to be displayed.

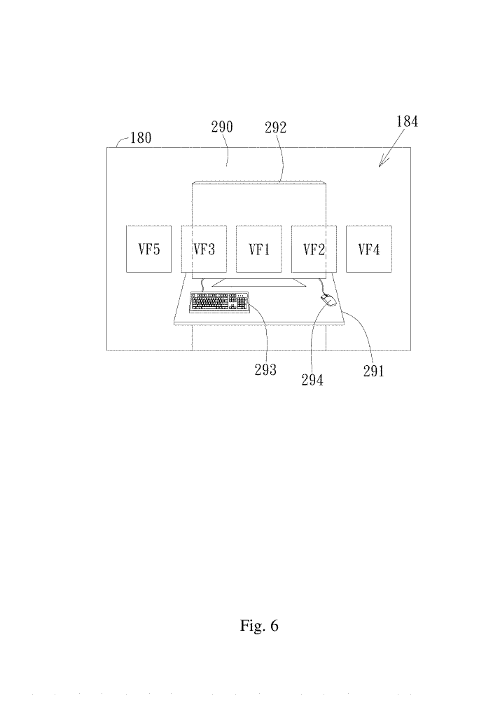

The image capture unit 233 is preferably disposed at a center location of the head mounted device 230, and is used to capture the real scene in front of the head mounted device 230. It transmits a reality video signal RS corresponding to the real scene to the video generating unit 260, and the video generating unit 260 combines the reality video signal RS with other video signals (such as the first video signal VS1 and the second video signal VS2) to generate a third mode picture and outputs it to the display screen 231 for display. For example, as shown in FIG. 6, which illustrates an example of a third mode picture 184, it includes multiple image pictures VF1-VF5 such as those shown in FIG. 2A as well as a reality picture 290 corresponding to the real scene capture by the image capture unit 233. In one embodiment, the reality picture 290 includes, without limitation, real background (such as wall or other objects, not shown in the drawing), desk 291, monitor 292, keyboard 293 and mouse 294. In a preferred embodiment, the image pictures VF1-VF5 obscure the objects located at the corresponding locations in the reality picture; for example, in FIG. 6, a portion of the monitor 292 is obscured by the image pictures VF1-VF3. With such a design, the user of the control terminal can simultaneously see the image pictures VF1-VF5 and the real work scene (the reality picture 290), which achieves an augmented reality (AR) experience.

The depth sensor 234 is used to provide depth of field information DOF about the real scene to the processing unit 270. The processing unit 270 adjusts the manner of display of the mode picture on the display screen 231 based on the depth of field information DOF. For example, as shown in FIG. 6, the user can adjust the display effect of the reality picture 290 using the depth sensor 234; for example, the user can set the effect such that the reality image portion within a specified depth of field (including the desk 291, monitor 292, keyboard 293 and mouse 294) is clearly displayed, while the reality image portion outside the specified depth of field (for example, the wall or other objects, not shown in the drawing) is displayed in a more blurred way. Or, the location of the reality picture may be adjusted based on the depth of field information DOF.

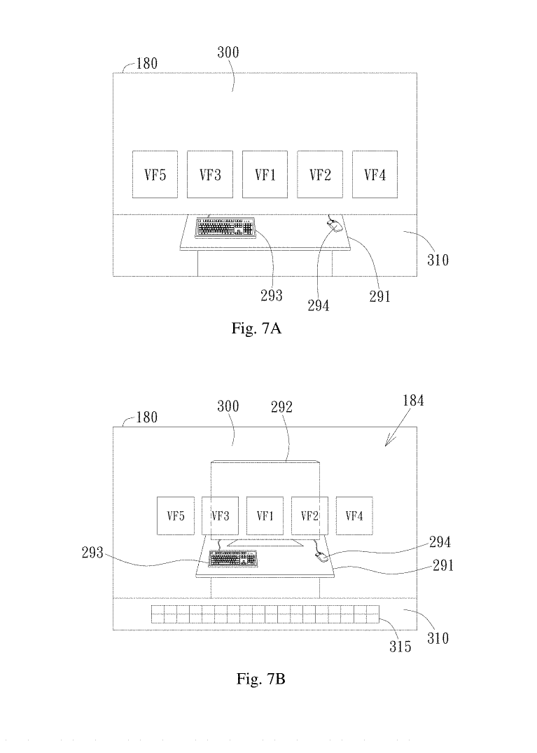

In one embodiment, as shown in FIG. 7A, the display screen 180 is set to have a video display region 300 and an avoidance region 310, such that the avoidance region 310 will not be obscured or covered by the various mode pictures. The video display region 300 is used to display the above mentioned browsing mode picture and locked mode picture, while the avoidance region 310 is used to display a part of the real scene. In this embodiment, the video display region 300 in FIG. 7A only displays the image pictures VF1-VF5, while the avoidance region 310 displays a part of the real scene of FIG. 6 (for example, it includes the desk 291, keyboard 293 and mouse 294). This way, the user can see the actual workbench using the real time display of reality picture in the avoidance region 310, which makes it convenient to operate various equipment on the workbench. In another embodiment, as shown in FIG. 7B, the video display region 300 may be set to display the third mode picture 184 as shown in FIG. 6, while the avoidance region 310 displays an operation interface 315 to allow the user to perform operations.

This invention also provides a video switching method, implemented in a video switching device and a head mounted device such as those described above. The video switching method includes the following steps. First, the video switching device receives a first video signal that forms a first image picture and a second video signal that forms a second image picture, and outputs a display video signal to the head mounted device to be displayed, where the display video signal is adjusted to form a first mode picture or a second mode picture, such as a browsing mode picture or a locked mode picture. Then, the video switching device, in response to a first sensing signal from the head mounted device, outputs a display video signal corresponding to the first mode picture or the second mode picture to the head mounted device for display, where the first sensing signal is generated in response to sensing a first movement gesture of the head mounted device, such as the user nodding his head.

In one embodiment, the first mode picture includes at least a portion of a first image picture and at least a portion of a second image picture, and the second mode picture includes at least an enlarged first image picture or an enlarged second image picture. Further, when the head mounted device displays the second mode picture, the video switching device, in response to a second sensing signal from the head mounted device, reduces the enlarged first image picture or the enlarged second image picture, and outputs the first mode picture to the head mounted device for display, where the second sensing signal is generated in response to sensing a second movement gesture of the head mounted device, such as the user shaking his head.

In one embodiment, the first mode picture includes at least a portion of a first image picture and at least a portion of a second image picture, and when the head mounted device displays the first mode picture, the video switching device, in response to a second sensing signal from the head mounted device, dynamically adjusts a display arrangement in the first mode picture, where the second sensing signal is generated in response to sensing a second movement gesture of the head mounted device, such as the user moving his head forward and backward.

In summary, in the video switching system according to embodiments of the present invention, the head mounted device (such as a VR glass) replaces conventional peripheral devices (including keyboard, monitor and mouse), i.e., the display screen of the VR glass replaces the conventional monitor screen, and operations of the VR glass replace the conventional control methods using keyboard and mouse. This provides a simple and effective method which introduces VR glass into a KVM switch system.

It will be apparent to those skilled in the art that various modification and variations can be made in the video switching apparatus, system and related method of the present invention without departing from the spirit or scope of the invention. Thus, it is intended that the present invention cover modifications and variations that come within the scope of the appended claims and their equivalents.

What is claimed is:

1. A video switching device configured to be coupled to a head mounted device and a sensing unit, the video switching device comprising:
a video generating unit, configured to receive a first video signal that forms a first video picture and a second video signal that forms a second video picture, and to generate a display video signal and output it to the head mounted device for display, wherein the display video signal is adjusted to form a first mode picture or a second mode picture, wherein the first mode picture includes at least a portion of the first video picture and at least a portion of the second video picture; and
a processing unit, configured to receive a first sensing signal from the sensing unit and to output a corresponding first switching signal to the video generating unit,
wherein the video generating unit is configured to generate the display video signal corresponding to the first mode picture or the second mode picture based on the first switching signal.

2. The video switching device of claim 1, wherein the second mode picture includes at least a portion of the first video picture and at least a portion of the second video picture, and wherein a relative relationship between the portion of the first video picture and the portion of the second video picture in the second mode picture is different from that in the first mode picture.

3. The video switching device of claim 1, wherein the second mode picture includes at least an enlarged first image picture or an enlarged second image picture.

4. The video switching device of claim 3, wherein the processing unit is further configured to receive a second sensing signal from the sensing unit and to output a corresponding second switching signal to the video generating unit,
wherein the video generating unit is further configured to, in response to the second switching signal, reduce the enlarged first image picture or the enlarged second image picture and output the display video signal corresponding to the first mode picture to the head mounted device for display.

5. The video switching device of claim 1, further comprising a receiving module, configured to receive the second video signal via a network, to convert the second video signal to a format that complies with a read and write format of the video generating unit, and to output the converted second video signal to the video generating unit.

6. The video switching device of claim 1, further comprising a first bridge unit configured to receive the first video signal and the second video signal and to output the first video signal and the second video signal to the video generating unit.

7. A video switching system, comprising:
a first video source, configured to provide a first video signal that forms a first image picture;
a second video source, configured to provide a second video signal that forms a second image picture;
a head mounted device, configured to be worn on a head of a user, and including a display screen;
a sensing unit, configured to sense a first movement gesture of the user's head and to output a first sensing signal;
a processing unit, configured to receive the first sensing signal and to output a corresponding first switching signal; and
a video generating unit, configured to receive the first video signal and the second video signal and to generate a display video signal and output it to the display screen for display, wherein the display video signal is adjusted to form a first mode picture or a second mode picture, wherein the first mode picture includes at least a portion of the first video picture and at least a portion of the second video picture;
wherein the video generating unit is further configured to, in response to receiving the first switching signal, generate the display video signal corresponding to the first mode picture or the second mode picture based on the first switching signal.

8. The video switching system of claim 7, wherein the second mode picture includes at least an enlarged first image picture or an enlarged second image picture.

9. The video switching system of claim 8, wherein the sensing unit is further configured to sense a second movement gesture of the user's head and to output a second sensing signal to the processing unit,
wherein the processing unit is further configured to output a corresponding second switching signal based on the second sensing signal,
wherein the video generating unit is further configured to, in response to receiving the second switching signal, reduce the enlarged first image picture or the enlarged second image picture and output the display video signal corresponding to the first mode picture to the head mounted device for display.

10. The video switching system of claim 7, further comprising:
a third video source, configured to provide a third video signal that forms a third image picture;
a bridge unit, configured to receive the first video signal and the third video signal; and
a control unit, coupled to the bridge unit, configured to selectively output either the first video signal or the third video signal to the video generating unit.

11. The video switching system of claim 7, further comprising:
a transmission module, coupled to the second video source, configured to encode the second video signal and transmit it via a network;
a bridge unit, configured to receive the second video signal via the network; and
a receiving module, coupled between the bridge unit and the video generating unit, configured to receive and decode the second video signal and to transmit the decoded second video signal to the video generating unit.

12. The video switching system of claim 7, further comprising at least one bridge unit, configured to receive the first video signal and the second video signal and to transmit the first video signal and the second video signal to the video generating unit.

13. The video switching system of claim 7, wherein the head mounted device further includes an image capture unit, configured to capture a real scene in front of the head mounted device and to transmit a reality video signal corresponding to the real scene to the video generating unit, wherein the video generating unit is further configured to combine the reality video signal, the first video signal and the second video signal to generate a third mode picture and output the third mode picture to the display screen for display.

14. The video switching system of claim 13, wherein the head mounted device further includes a depth sensor configured to provide depth of field information about the real scene to the processing unit, and wherein the processing unit is configured to adjust a manner of display of the third mode picture based on the depth of field information.

15. The video switching system of claim 14, wherein the display screen includes a video display region and an avoidance region, wherein the first mode picture, the second mode picture and the third mode picture are displayed in the video display region and a portion of the real scene is displayed in the avoidance region.

16. The video switching system of claim 7, wherein the display screen includes a video display region and an avoidance region, wherein the first mode picture and the second mode picture are displayed in the video display region and an operation interface is displayed in the avoidance region.

17. The video switching system of claim 7, wherein the sensing unit is disposed on the head mounted device, and wherein the sensing unit includes a gravity sensor or a gyroscope.

18. A video switching method, implemented in a video switching device and a head mounted device, the method comprising:
the video switching device receiving a first video signal that forms a first image picture and a second video signal that forms a second image picture, and outputting a display video signal to the head mounted device for display, wherein the display video signal is adjusted to form a first mode picture or a second mode picture; and
the video switching device, in response to a first sensing signal from the head mounted device, outputting a display video signal corresponding to the first mode picture or the second mode picture to the head mounted device for display, where the first sensing signal is generated in response to sensing a first movement gesture of the head mounted device.

19. The video switching method of claim 18, wherein the first mode picture includes at least a portion of the first video picture and at least a portion of the second video picture, the second mode picture includes at least an enlarged first video picture or an enlarged second video picture,
the method further comprising, when the head mounted device displays the second mode picture:
the video switching device, in response to a second sensing signal from the sensing unit, reducing the enlarged first image picture or the enlarged second image picture, and outputting the first mode picture to the head mounted device for display, wherein the second sensing signal is generated in response to sensing a second movement gesture of the head mounted device.

20. The video switching method of claim 18, wherein the first mode picture includes at least a portion of the first video picture and at least a portion of the second video picture,
the method further comprising, when the head mounted device displays the first mode picture:
the video switching device, in response to a second sensing signal from the sensing unit, dynamically adjusts a display arrangement in the first mode picture, where the second sensing signal is generated in response to sensing a second movement gesture of the head mounted device.
